(19) United States
(12) Patent Application Publication
(10) Pub. No.: US 2023/0398027 A1
(43) Pub. Date: Dec. 14, 2023

(54) PATIENT SLING

(71) Applicant: Arjo IP Holding Aktiebolag, Malmö (SE)

(72) Inventors: Genevieve MIRON, Sherbrooke, Québec (CA); Marie-Josée TOUPIN, Racine, Québec (CA); Denis-Alexandre BRULOTTE, Orford, Québec (CA); Marianne-Coquelicot MERCIER, Montréal, Québec (CA); Audrey COULOMBE, Sainte Marcelline de Kildare, Québec (CA)

(73) Assignee: Arjo IP Holding Aktiebolag, Malmö (SE)

(21) Appl. No.: 18/033,571

(22) PCT Filed: Oct. 21, 2021
(86) PCT No.: PCT/SE2021/051051

§ 371 Date: Apr. 25, 2023

(30) Foreign Application Priority Data
Oct. 26, 2020 (SE) 2051246-3

(51) Int. Cl. A61G 7/10

(52) U.S. Cl. CPC A61G 7/1051

(57) ABSTRACT

A body support sling (100) for supporting a patient from a patient hoist (10). The sling (100) comprises a leg support portion (60) adapted to support the thighs of a patient and a torso support portion (70) adapted to support the torso of a patient. According to an aspect of the invention, the sling (100) comprises a connecting portion (40). The connecting portion (40) comprising a front pair of suspension straps (41, 42) and a rear pair of suspension straps (43, 44) each being adapted to be connected to the patient hoist (10), the front pair of suspension straps (41, 42) being adapted to extend in front of the patient and the rear pair of suspension straps (43, 44) being adapted to extend behind the patient when the sling (100) is worn by the patient. The rear pair of suspension straps (43, 44) are attached to the torso support portion (70) and the front pair of suspension straps (41, 42) are attached to the leg support portion (60).

### TECHNOLOGY FIELD

The present invention relates to the technical field of patient slings. In more detail, the present invention relates to a body support sling for supporting a patient from a patient hoist.

### BACKGROUND

Patient lifts, also referred to as patient hoists, are commonly used to raise, lower and transfer patients who are disabled or who otherwise have mobility problems. Two common types of patient lifts are stanchion-mounted lifts, also known as floor lifts. and ceiling lifts. Floor lifts often have a hoist assembly. The hoist assembly may be disposed at the upper end of a stanchion. The stanchion has a wheeled base, which allows for the lift to be moved along the ground to different locations.

For example, the lift might be wheeled to position the hoist assembly and lifting member over or adjacent to a patient. A lifting member may then be lowered to receive the patient and subsequently raise the lifting member and patient so that they may be wheeled elsewhere to be lowered and placed.

A ceiling lift may be utilized in a similar manner; however, the hoist assembly is movably engaged to ceiling-mounted tracks such that the hoist assembly can be moved about the track from location to location. A ceiling lift may be described as a motor unit movable along a rail, a flexible member is attached to a lifting member in the form of a spreader bar. The motor unit commonly comprises a transmission, batteries and a control module.

Generally, the lifting member which may be in the form of a spreader bar, such as a two-point attachment spreader bar, a three-point attachment spreader bar, a four-point attachment spreader bar, a five-point attachment spreader bar or a powered spreader bar for adjusting the angle of the patient in the spreader bar, for suspending a patient harness or sling.

In order to lift the patient, a patient sling is attached to the spreader bar. The patient is seated or lays on top of the patient sling, whereby the patient lift raises the patient sling and thereby the patient.

Conventional patient slings are usually only suitable for a particular type of lifting such as lifting of seated patients, lifting of laying patients and supporting standing patients. Hence, depending on the lifting operation the hospital personnel may have to switch between different patient slings, which is both cumbersome and time-consuming.

Furthermore, most slings, which are possible to apply to a patient when the patient is in a seated position, are difficult to install and adjust on the patient.

Another issue with such slings is that they are uncomfortable if used for supporting a standing patient, particularly during walking training and in case of fall. This is due to tension applied on the torso support portion of the sling causing the sling to move up on the patient as well as discomfort in the crotch area of the patient.

In field of walking training and patient rehabilitation, the usage of so-called dynamic lifts has increased. Dynamic lifts provides dynamic unloading based on the load exerted by the patient to the spreader bar or sling or the elevation of the sling. Hence, when the walking patient begins to fall or lose balance the motor controlling the lift provides additional lifting force allowing the lift to pull the patient back to standing. This is associated with additional challenges for the sling since the sling has to provide comfortable support even during rapid movement and loading or unloading. Also the inventors has identified a need for a sling suitable both for dynamic and conventional lifts.

### SUMMARY

According to one aspect, a body support sling for supporting a patient from a patient hoist is provided. The sling comprises a leg support portion adapted to support the thighs of a patient, a torso support portion adapted to support the torso of a patient and a connecting portion. The connecting portion comprises a front pair of suspension straps and a rear pair of suspension straps each being adapted to be connected to the patient hoist. The front pair of suspension straps are adapted to extend in front of the patient and the rear pair of suspension straps being adapted to extend behind the patient when the sling is worn by the patient.

The rear pair of suspension straps are attached to the torso support portion and the front pair of suspension straps are attached to the leg support portion.

According to one aspect, a body support sling for supporting a patient is provided. The sling comprises a leg support portion adapted to support the thighs of a patient, a torso support portion adapted to support the torso of a patient. The sling further comprises at least one rigid element connected to the torso support portion. The rigid element is adapted to be connected to a patient hoist.

According to one aspect, a body support sling for supporting a patient is provided. The sling comprises a leg support portion adapted to support the thighs of a patient, a torso support portion adapted to support the torso of a patient and a connecting portion adapted to be connected to a patient hoist. The leg support portion comprises a first leg support member and a second leg support member each adapted to wrap around the thigh of the patient, respectively. The first leg support member and the second leg support member each has an upper edge adapted to be inclined from a first higher position proximal to an outer side of the thigh of the patient to a second lower position proximal to an inner side of the thigh of the patient.

According to one aspect, a body support sling for supporting a patient is provided. The leg support portion comprises a first leg support member and a second leg support member each adapted to wrap around the thigh of the patient, respectively. The first leg support member and the second leg support member each comprises a torso attachment portion attached to the torso support portion. The torso attachment portion of the first leg support member and the second leg support member are each adapted to extend at an angle towards the back of the thighs of the patient when the sling is worn by the patient.

According to an aspect, a body support sling for supporting a patient is provided. The sling comprises a leg support portion adapted to support the thighs of the patient. The sling comprises a torso support portion adapted to support the torso of a patient and a connecting portion adapted to be connected to a patient hoist. The torso support portion is adapted to wrap around the torso of the patient. The torso support portion comprises at least one coupling connection configured to releasably connect opposite ends of the torso support portion. The leg support portion comprises a first leg support member and a second leg support member, each adapted to wrap around the first and second thigh of the patient, respectively. The first and second leg support member each comprises a first and second end connectable by means of a leg support member connector, said leg support member connectors being configured to be proximal to the front of the thigh of the patient when the sling is worn by the patient.

Further objects and features of the present invention will appear from the following detailed description of embodiments of the invention.

### BRIEF DESCRIPTION OF DRAWINGS

The invention will be described with reference to the accompanying drawings, in which:

FIG. 1 is a front view of a sling according to one embodiment worn by a standing patient.

FIG. 2 is a back view of a sling according to one embodiment worn by a standing patient.

FIG. 3 is a side view of a sling according to one embodiment worn by a standing patient.

FIG. 4 is a perspective view of a sling according to one embodiment worn by a patient hanging from the sling in a seated position.

FIG. 5 is a side view of a sling according to one embodiment worn by a standing patient.

### DETAILED DESCRIPTION

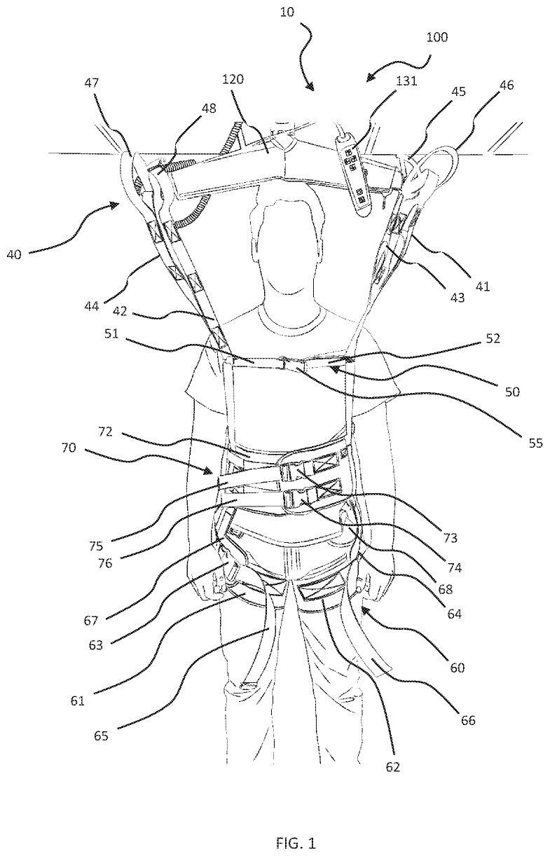

FIG. 1 depicts a body support sling 100. The sling 100 is for supporting a patient from a patient hoist 10. As seen in FIG. 1, the patient hoist 10 may have a spreader bar 120. The spreader bar 120 may be a two-point or four-point spreader bar.

Supporting may herein refer to providing support to the patient while said sling is worn by the patient. This may be for example during transferring, ambulating, exercising, walking or standing. Thus, the sling may be adapted to provide support to the patient during any one of transferring, ambulating, standing, and walking. The sling may be adapted to suspend the patient from the patient hoist 10.

Thus, the sling 100 may be suitable for any one of transferring a patient, ambulating a patient, lifting a patient and providing support for a patient which is standing or walking.

In the depicted example, the patient hoist 10 is a ceiling lift with a rail mounted lifting unit provided with the spreader bar 120. The ceiling lift may be a dynamic ceiling lift, which is configured to dynamically unload the patient while the patient moves around, or a conventional ceiling lift, which is configured to raise and lower a patient in a linear manner. In an alternative embodiment, the patient hoist may be a floor lift. The floor lift comprising a wheel-mounted platform with a vertically extending unit provided with the lifting unit, the lifting unit being provided with the spreader bar 120. In yet another alternative embodiment, the patient hoist may be a rising or standing aid configured to support a patient from a sitting position to a standing position. The patient hoist may have a pivotable lifting member driven to lift the thighs and back of the seated patient in a standing direction.

The sling 100 comprises a leg support portion 60. The leg support portion 60 is adapted to support the thighs of a patient. Accordingly, the leg support portion 60 is adapted to support the thighs of a patient when the sling 100 is installed on the patient, i.e. worn by the patient.

The sling 100 comprises a torso support portion 70. The torso support portion 70 is adapted to support the torso of the patient. Accordingly, the torso support portion 70 is adapted to support the torso of the patient when the sling 100 is installed on the patient, i.e. worn by the patient.

The sling 100 may comprise a connecting portion 40. The connection portion may be adapted to be attached to the patient hoist 10.

In one embodiment, the connecting portion 40 comprises a front pair of suspension straps 41, 42. The front pair of suspension straps may comprise a first front suspension strap 41 and a second front suspension strap 42. The connecting portion 40 further comprises a rear pair of suspension straps 43, 44. The rear pair of suspension straps 43, 44 may comprise a first rear suspension strap 43 and a second rear suspension straps 44.

The rear pair of suspension straps 43, 44 are attached to the torso support portion 70. The front pair of suspension straps 41, 42 are attached to the leg support portion 60.

This ensures that the pulling force is directed to the patient hipbone (iliac crest) in order to better emulate the natural sit to stand motion by allowing frontward flexion of the upper body of the patient, i.e. the patient depicted in the aforementioned figure. Hence, a more ergonomic sling is achieved which also is suitable both for lifting and supporting a standing or walking patient as well as helping a sitting patient to a standing position.

The front pair of suspension straps 41, 42 extends from the hoist to the leg support when the sling is mounted to the hoist. Preferably, the front pair of suspension straps 41, 42 are only connected to the leg support portion 60. Thus, the front pair suspension straps 41, 42 are not attached to the torso support portion 70.

The majority of the load is thus taken by the front suspension straps. The sling allows for better frontward body flexion and better emulates a natural sit to stand motion. In addition, the sling also brings the patient back to a comfortable seated position in case of fall.

Accordingly, the front pair of suspension straps 41, 42 may be longer than the rear pair of suspension straps 43, 44.

The sling may be made of a woven material. In an alternative embodiment, the sling may be made of a non-oven material.

In one embodiment, the sling is made of a wipeable material. Accordingly, the sling may be made of non-porous or may comprise an outer wipeable coating.

The leg support portion 60 may have a uniform seating portion, i.e. a seating portion in one piece adapted to support the rear of the patient, or separate support portion for individually supporting the legs/thighs of the patient. With reference to FIG. 1, the leg support portion 60 comprises a first leg support member 62 and a second leg support member 61. The first leg support member 62 is adapted to wrap around a first thigh of the patient. The second leg support member 61 is adapted to wrap around the second thigh of the patient. The leg bands wrapping around the thighs of the patient allows for a more comfortable sling.

The first leg support member 62 may be a first leg band. The second leg support member 61 may be a second leg band.

Further referencing FIG. 1, the first leg support member 62 and the second leg support member 61 are arranged such that an upper outer edge of said first leg support member 62 and second leg support member 61 have a downward inward inclination. Accordingly, the first leg support member 62 has an upper edge arranged be inclined from a first higher position proximal to an outer side of the first thigh of the patient to a second lower position proximal to an inner side of the first thigh of the patient. The second leg support member 61 has an upper edge adapted to be inclined from a first higher position proximal to an outer side of the second thigh of the patient to a second lower position proximal to an inner side of the second thigh of the patient. Hence, the leg band may be considered a shaped leg band, i.e. a leg band following the shape of the thigh of the patient.

The sling 100 may have a longitudinal central axis corresponding to the center of the body of the patient when the patient wears the sling. Accordingly, the upper edge of the first leg support member 62 may extend diagonally and downwards towards the longitudinal central axis when the sling is worn by the patient. Correspondingly, the upper edge of the second leg support member 61 may extend diagonally and downwards towards the longitudinal central axis when the sling is worn by the patient.

This allows for an improved pressure distribution over the entire thigh which greatly improves the comfort. Further, the angled position of the leg support members reduces the risk for pinching and the leg band rising in the crotch when in tension.

In one embodiment, the first leg support member 62 and the second leg support member 61 may be padded to further increase the comfort.

Further referencing FIG. 1, the torso support portion 70 may be adapted to wrap around the torso of the patient. The torso support portion 70 may comprise at least one coupling connection 73, 74. The at least one coupling connection 73, 74 is configured to releasably connect the opposite ends of the torso support portion 70. The at least one coupling connection 73, 74 may be adapted to be in front of the patient when the sling is mounted to or worn by the patient. This makes it easier for the care personnel to mount the sling to the patient.

The torso support portion 70 may comprise a first belt strap 75 and a second belt strap 76. The first belt strap 75 is provided with a first coupling connection 73. The second belt strap 76 is provided with a second coupling connection 74. The coupling connections are adjustable by means of said belt straps. The belt straps accommodates adjustment for different patient morphologies.

Again referencing FIG. 1, the sling 100 may further comprise a chest strap 50. The chest strap 50 connects the front pair of suspension straps 41, 42. Thus, a first end of the chest strap 50 is connected to the first front suspension strap 41 and a second end of the chest strap 50 is connected to the second front suspension strap 42. The chest strap mitigates the risk of the patient falling between the front suspension straps. The chest strap also clears arms and shoulders away from the front pair of suspension straps which gives the patient a larger degree of freedom of motion. This is particularly advantageous since it allows the patient to perform exercises and activities.

The chest strap 50 is arranged parallel to the torso support portion 70. The chest strap 50 is arranged at a distance from said torso support portion 70 along the front pair of suspension straps 41, 42. The chest strap 50 is adapted to extend in front of the chest of the patient. Accordingly, the chest strap 50 is transversal to the front pair of suspension strap.

In one embodiment, the chest strap 50 is adjustable to alter the distance between the front pair of suspension straps 41, 42, i.e. the distance between the first suspension strap 41 and the second suspension strap 42. Compared to a conventional sling this allows for further adaptation of the sling for various patient morphologies.

The chest strap 50 may comprise a first chest strap member 52 connected to the first front suspension strap 41. The chest strap 50 may further comprise a second chest strap member 51 connected to the second front attachment 42. The first and second chest strap members are connectable by means of a coupling 55. The coupling 55 may be a snap-coupling.

The chest strap 50 may be adjustable to alter the distance between the front pair of suspension straps 41, 42 by means of the first chest strap member 52 and second chest strap member 51 each being adjustably connected to the coupling 55.

In one embodiment, the chest strap 50 is adjustable along the length of the front pair of suspension straps 41, 42. Accordingly, the distance between the torso support portion 70 and the chest strap 50 is adjustable. The chest strap 50 is thus movably connected to the first front suspension strap 41 and the second front suspension strap 42. Thus, the first chest strap member 52 is movably connected to the first suspension strap 41 and the second chest strap member 51 is movably connected to the second suspension strap 42. Hence, a sling, which may mitigate the patient falling forward between the front pair of suspension straps for patient with different morphologies, is achieved.

The chest strap 50 may be adjustably connected to the front pair of suspension strap 41, 42 in any suitable manner which allows for sliding movement relative to said front pair of suspension strap. In one embodiment, the chest strap 50 may be provided with loops, whereby the front pair of suspension straps 41, 42 are arranged to extend through said loops. The loops may be sewn or welded to the chest strap 50. In one embodiment, the chest strap 50 may be provided with adjustable clips, i.e. adjustable sternum clips. The adjustable clips each being connected to each of the front suspension straps for adjustment of the chest strap 50 along the length of the front pair of suspension straps 41, 42. The adjustable clips may be in metal or plastic.

As depicted in FIG. 1, each of the suspension straps may comprise a hoist coupling member 45, 46, 47, 48 configured to couple the sling 100 to the patient hoist 10. The hoist coupling members 45, 46, 47, 48 may be adapted to couple the sling 100 to a spreader bar 120 of the patient hoist 10. The hoist coupling members 45, 46, 47, 48 may be in the form of loops.

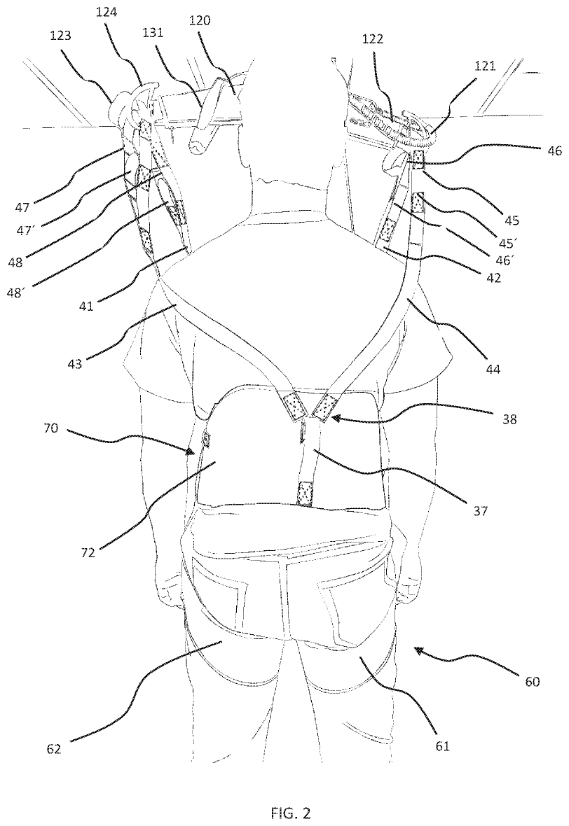

Turning to FIG. 2, a back view of the sling 100 is provided. The sling 100 has a back portion 72. The back portion 72 is adapted to provide back support to the patient when the sling 100 is mounted to said patient, i.e. worn by the patient. Thus, the back portion 72 is adapted to be proximal to the back of the patient.

As depicted in FIG. 2, the rear pair of suspension straps 43, 44 are attached to a common attachment point 38 on the back portion 72 of the torsion support portion 70. The common attachment point may be a central common attachment point of the torso support portion.

The first rear suspension strap 43 and second rear suspension strap 44 may thus be attached to the common attachment point of the back portion 72. In one embodiment, the rear pair of suspension straps 43, 44 may be arranged in a V-configuration from the common attachment point 38. Hence, the first rear suspension strap 43 may be arranged in an outward angle away from the longitudinal central axis. Correspondingly, the second rear suspension strap 44 may be arranged in an outward angle away from the longitudinal central axis, the angle being opposite to the angle of the first rear suspension strap 43.

The V-configuration of the rear suspension straps allows for the patient to be caught and supported in a more comfortable manner in the case of a fall. This is particularly advantageous since the patient may fall over during exercises performed when supported by the sling.

In one embodiment, the back portion 72 of the torso support portion 70 has a concave shape. The concave shape is particularly advantageous if the sling is used with a standing and raising aid since it allows easer access for the caregiver for performing hygienic tasks. Furthermore, the concave shape mitigates pressure points, which improves the comfort of the sling.

The torso support portion 70 is provided with at least one handle element 37. In one embodiment, the back portion 72 may be provided with a handle element 37. A handle element on the back portion allows the caregiver to pull the patient at the back of a chair when seating the patient on the chair with the sling. In one embodiment, the torso support portion 70 may be provided with at least one handle element extending from the side of the patient. In one embodiment, the torso support portion 70 may be provided with a handle element extending from a first side of the patient and a handle element extending from a second side opposite side of the patient. A side handle element allows the caregiver to guide motion provide tactile cueing during rehabilitation and motion activities.

Further referencing FIG. 2, wherein at least one strap of the front pair of suspension straps 41, 42 and the rear pair of suspension straps 43, 44 are adjustable to adjust the distance between the patient hoist 120 and the torso support portion 70.

This allows for compensation for a patient having a tilted posture and adjustment of assistance level depending on which activities the patient is performing. Furthermore, it allows adapting the sling to provide clearance for the head for patients having different heights.

In other words, at least one of the suspension straps 41, 42, 43, 44 may be adjustable to adjust the distance between the hoist coupling member 45, 46, 47, 48 and the torso support portion 70. The at least one strap of the front pair of suspension straps 41, 42 and the rear pair of suspension straps 43, 44 may be adjustable by means of adjustable buckles or clips. Preferably each of the straps of the front and rear pair of suspension straps may be adjustable by means of adjustable buckles or clips. Preferably, the front pair of suspension 41, 42 straps may be connected to the leg support members by means of adjustable buckles or clips. Similarly, the rear pair of suspension straps 43, 44 may be connected to the torso support portion by means of adjustable buckles or clips.

In one embodiment, all of the straps of the front and rear pair of suspension straps are adjustable to adjust the distance between the patient hoist 10 and the torso support portion 70. In one embodiment, all of the straps of the front and rear pair of suspension straps are adjustable to adjust the distance between the spreader bar 120 and the torso support portion 70.

In one embodiment, the torso support portion 70 may have a concave shape with the wider portion being arranged to support the back of the patient, .e.g when the sling is worn by the patient. The narrower portion of the torso support portion 70 may be arranged to extend adjacent to the ribs and/or chest of the patient. Thus, a central portion of the torso support portion 70 may be wider than a first and second side portion of the torso support portion 70 on each side of side central portion.

Thereby, the line, instrumentation and as well as the breast of the patient may be accommodated while the sling may provide sufficient back support.

In FIG. 2, at least one strap is provided with a plurality of coupling members. Accordingly, the at least one strap of the front pair of suspension straps 41, 42 and the rear pair of suspension straps 43, 44 are provided with at least two hoist coupling members 45, 45′, 46, 46′, 47, 47′, 48, 48′. The at least two hoist coupling members may be provided at a distance from each other along the length of the at least one suspension strap. The hoist coupling members are configured to couple the sling 100 to the patient hoist 10. In one embodiment, the hoist coupling members are configured to couple the sling to the spreader bar 120.

The multiple hoist coupling members on the same strap allows the care personnel to adapt the sling in a simple manner, i.e. by just choosing the appropriate hoist coupling member for attaching to the hoist. Further, it allows for straps with an adjustable length without introduction of additional buckles etc. which makes it more robust and less expensive.

In one embodiment, the at least two hoist coupling members may be in the form of loops attached to the strap.

In one embodiment, each of the suspension straps of the front pair 41, 42 of suspension straps and rear pair of suspension strap 43, 44 may comprise at least two hoist coupling members 45, 45′, 46, 46′, 47, 47′, 48, 48′ provided at a distance from each other along the length of each suspension strap.

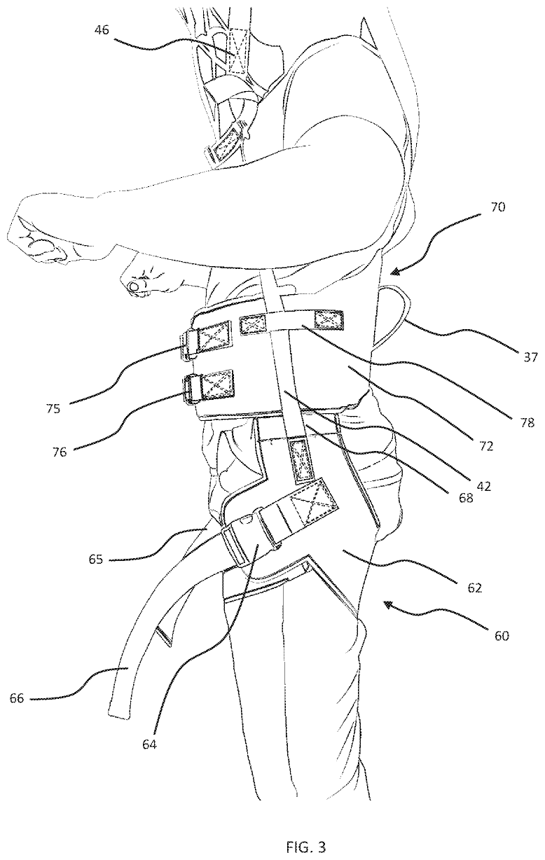

Referring to FIGS. 1 and 3, the first leg support member 62 comprises a torso attachment portion 67 (shown in FIG. 1). The torso attachment portion 67 of the first leg support member 62 is attached to the torso support portion 70. Correspondingly, the second leg support member 61 comprises a torso attachment portion 68. The torso attachment portion 68 of the second leg support member 61 is attached to the torso support portion 70.

As seen in FIG. 3, the first and second leg support member may each comprise a thigh-wrapping portion adapted to wrap around the thigh of the patient. The torso attachment portion 68 extends from said thigh-wrapping portion to the torso support portion 70.

Thus, the first and second leg support member 62, 61 may each comprise a thigh-wrapping portion adapted to wrap around the thigh of the patient. The torso attachment portion 68 of the first leg support member 62 extends from the thigh-wrapping portion of the first leg support member 62 to the torso support portion 70. Similarly, the torso attachment portion 67 of the second leg support member 61 extends from the thigh-wrapping portion of the first second support member 61 to the torso support portion 70.

Preferably, the thigh-wrapping portions are padded and the torso attachment portions 67, 68 are unpadded. Thus, the torso attachment portions 67, 68 may be in a textile material and the thigh wrapping portion may comprise a layer of padding or cushioning material. This allows for an increased mobility in the sling for the patient, since relative movement between the torso support portion and the leg support members is accommodated by the unpadded material of the torso attachment portion.

The torso attachment portion 68 is inclined relative a straight direction extending from the thigh-wrapping portion to the torso support portion 70. In one embodiment, the torso attachment portion 67 of the first leg support member 62 is adapted to extend at an angle towards the back of the thigh, i.e. first thigh, of the patient. Similarly, the torso attachment portion 68 of the second leg support member 61 is adapted to extend at an angle towards the back of the thigh, i.e. second thigh, of the patient. Hence, the torso attachment portion has an inclined orientation, preferably when the patient is in a standing portion. This allows for sufficient support of the legs while allowing access for the care personnel to perform hygiene tasks to the patient since there may be sufficient space between the torso support portion and the leg support members.

Preferably, the torso attachment portion of the first and the second leg support member is each adapted to extend at an angle towards the back of the thighs of the patient at least when the sling is worn by the patient in a standing position.

In one embodiment, an inner edge of the torso attachment portion 67, 68 of the first and second leg support member 62, 61 is inclined outwardly towards the back of the thigh of the patient. Thus the inner edge of the torso attachment portion 67, 68 of the first leg support member 62 and the second leg support member 61 each are adapted to extend at an angle towards the back of the thighs of the patient when the sling 100 is worn by the patient.

In one embodiment, the outer edges of the leg support portion 60 are padded. Thus, the pressure distribution is improved resulting in an improved comfort.

The thigh-wrapping portion of the first leg support member 62 and the second leg support member 61 may comprise a first and second end connectable by means of a leg support member connector 64, 63 (as seen in FIG. 1 and FIG. 3). Preferably, the leg support member connector 64 of the first leg support member 62 and the leg support member connector 63 of the second leg support member 61 are configured to be proximal to the front of the thigh of the patient when the sling 100 is worn by the patient. Thus, the hospital personnel may access the connector easily when mounting the sling to the patient, making the sling more user friendly.

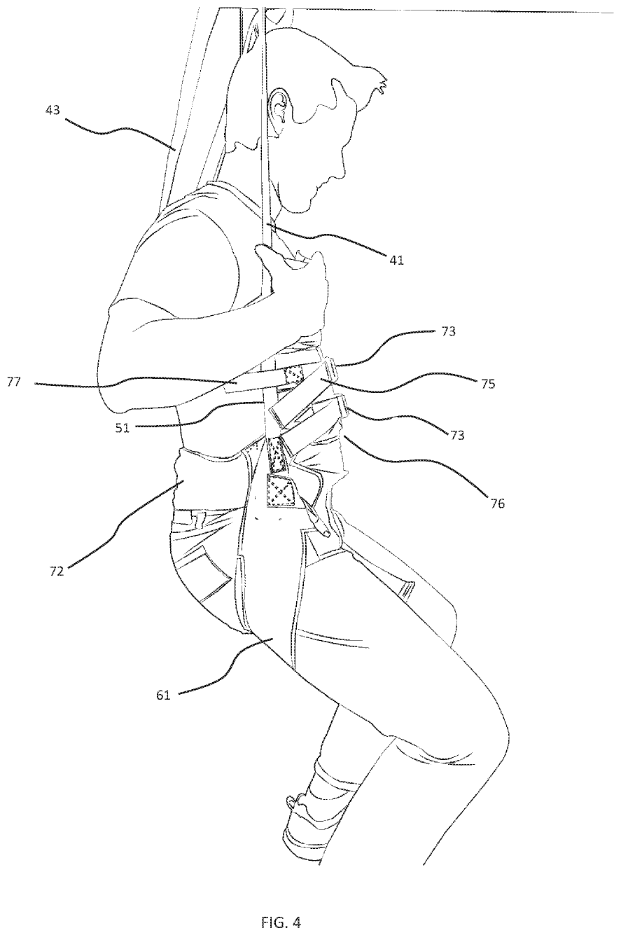

Referencing FIGS. 3 and 4, the torso support portion 70 comprises a guiding arrangement 77, 78. The front pair of suspension straps 41, 42 are adapted to pass through the guiding arrangement for securing a position of the front pair of suspension straps 41, 42 in front of the patient (when the sling is worn by the patient). This allows for the front pair of suspension straps 41, 42 to prevent the patient falling forward. Instead, the patient falling forward comes into contact with the front pair of suspension straps 41, 42, whereby the falling motion is halted. Compared to having fixed connection points securing the front pair of suspension straps, this mitigates the risk for the torso support portion being pulled upwards due to the front pair of suspension straps pulling the torso support portion via the fixed connection points. Thus, the guiding arrangement 77, 78 may be arranged to allow for sliding movement of the front pair of suspension straps along the length of said front pair of suspension straps.

Again referencing FIGS. 3 and 4, in one embodiment, the torso support portion may comprise the guiding arrangement 77, 78. The front pair of suspension straps 41, 42 are adapted to pass through the guiding arrangement 77, 78 for limiting relative movement between the leg support portion 60 and the torso support portion 70. Thus, a more stable sling which provides more support to the patient during walking, standing or exercising is achieved.

The guiding arrangement 77, 78 may be in the form of loops. Thus, in one embodiment, the guiding arrangement 77, 78 comprises a first guiding loop 77 and a second guiding loop 78. The first guiding loop 77 is adapted to receive the first front suspension strap 41. The second guiding loop 78 is adapted to receive the second front suspension strap 42.

Again referencing FIGS. 1 and 3, the first front suspension strap 41 of the front pair of suspension straps 41, 42 is attached to an attachment point of the first leg support member 62. The second front suspension strap 42 is attached to an attachment point of the second leg support member 61.

The attachment point of the first leg support member 62 is adapted to be proximal to an outer side of the thigh of the patient, i.e. the first thigh of the patient. Accordingly, the attachment point of the first leg support member 62 is provided at a position which will be proximal to the outer side of the thigh of the patient. Outer side herein refers to the distant side of the first thigh relative the longitudinal center axis. The attachment point of the second leg support member 61 is adapted to be proximal to an outer side of the thigh of the patient, i.e. the second thigh of the patient. Accordingly, the attachment point of the second leg support member 61 is provided at a position which will be proximal to the outer side of the thigh of the patient. Outer side herein refers to the distant side of the second thigh relative the longitudinal center axis.

Hence, a portion the first suspension strap 41 is adapted to extend along at least a portion of the outer side of the first thigh when the patient is in a standing position. A portion of the second suspension strap 42 is adapted to extend along at least a portion of the outer side of the second thigh when the patient is in a standing position. This allows for support around the iliac crest of the patient. Thereby, the support provided by the sling is provided in a manner which more naturally follows the anatomy of the patient making it more comfortable and suitable for usage in cases where the patient performs training actions.

In FIG. 4 a patient supported by means of the sling in a seated position is depicted. In the seated position, the torso support portion 70 supports the back of the patient while the leg support portion 60 supports, i.e. unloads and/or carries, the back of the thighs of the patient.

The attachment point of the first leg support member 62 may be positioned such that the attachment point of the first leg support member 62 is proximal to a front side of the thigh of the patient when the sling is worn by the patient, i.e. worn by the patient. The attachment of the second leg support member 61 may be positioned such that the attachment point of the second leg support member 61 is proximal to a front side of the other thigh when the sling is worn by the patient, i.e. worn by the patient. This allows for further support and additional comfort when the patient is in the seated position in the sling.

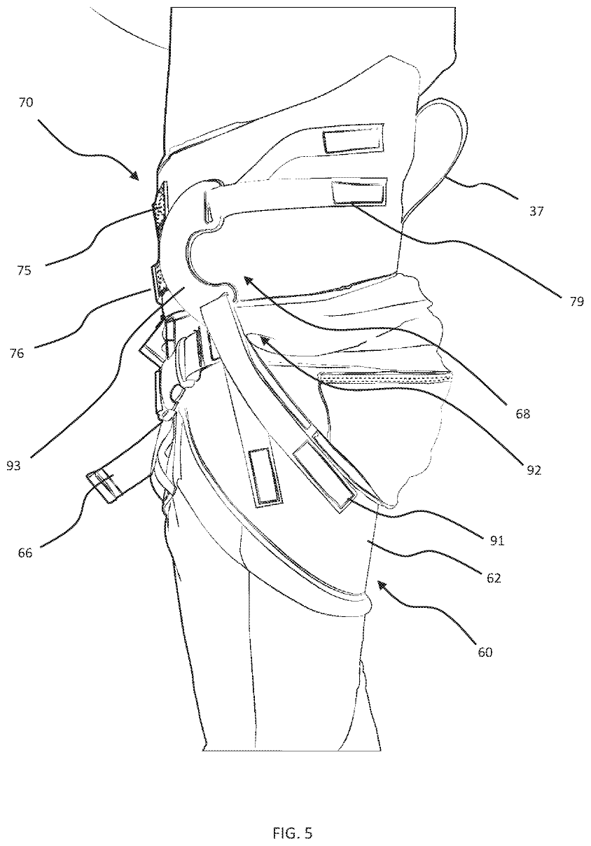

FIG. 5 discloses a side view of a sling according to one embodiment. The sling design depicted in FIG. 5 may be utilized with or without the suspension straps described with reference to FIGS. 1-4.

The sling 100 may further comprise a first connecting strap 92 (not shown in FIG. 5) connected to the first leg support member 62 and the torso support portion 70. A first end of the first connecting strap 92 is connected to the first leg support member 62. A second end, which is opposite to the first end, of the first connecting strap 92 is connected to the torso support portion 70. The sling 100 may further comprise a second connecting strap 92 connected to the second leg support member 61 and the torso support portion 70. A first end of the second connecting member 92 is connected to the second leg support member 61. A second end, which is opposite to the first end, of the second connecting strap 92 is connected to the torso support portion 70. The first and second strap 92 are adapted to extend in front of the patient and be connected to the patient hoist 10.

The pair of connecting straps 92 allows for a connection to a patient hoist in front of the patient. Thus, the pair of connecting straps 92 are advantageously attached to a patient hoist in the form of a raising aid for pulling a patient from a seated position to a standing position. Thereby, a sling that is suitable for both raising aids and lifting aids is achieved.

Preferably, the first and second connecting strap 92 may comprise a rigid element 93. The rigid element 93 is configured to be connected to the patient hoist 10. The rigid element 93 may be an in a polymer material.

The rigid element allows for some relative movement between the patient hoist and the connecting strap during an aided raise, which allows the patient to perform the rising motion. Further, the rigid element is more resistant to wear and tear compared to a textile or canvas strap for example.

In one embodiment, the rigid element 93 is C-shaped for interfacing with the patient hoist 10. Alternatively or additionally, the rigid element 93 comprises a rounded recess for interfacing with the patient hoist 10.

Further referencing FIG. 5, each of the connecting straps 92 comprises a first strap member 91 attached to the leg support portion 60, i.e. to the first and second leg support member 62, 61, respectively. Each of the connecting straps 92 also comprises a second strap member 79 attached to the torso support portion 70. The first strap member and the second strap member are interconnected by means of the rigid element 93.

The first and second strap member may be in the form of loops attached to the leg support portion and the torso support portion, respectively.

According to an aspect of the invention, a body support sling 100 for supporting a patient from the patient hoist 10 or supporting a patient is provided. The sling 100 comprises the leg support portion 60 adapted to support the thighs of a patient when the sling 100 is worn by the patient. The sling 100 further comprises the torso support portion 70. The torso support 70 is adapted to support the torso of a patient, the sling 100 comprises the rigid element 93. The rigid element 93 is adapted to be connected to the patient hoist 10. Hence, the sling may be provided with or without the previously described suspension straps. The sling may share the features previously described with reference to FIG. 1-5.

In one embodiment, the leg support portion 60 and the torso support portion 70 may be connected by means of the rigid element 93.

In one embodiment, the leg support portion 60 comprises the first leg support member 62 (not shown in FIG. 5, but depicted in FIG. 1-3) and the second leg support member 61. The first leg support member 62 is adapted to wrap around the first thigh of the patient. The second leg support member 61 is adapted to wrap around the second thigh of the patient.

In one embodiment, the sling 100 may further comprise the first connecting strap 92 and the second connecting strap 92. The first connecting strap 92 is connected to the first leg support member 62 and the torso support portion 70. The second connecting strap 92 is connected to the second leg support member 61 and the torso support portion 70 (as previously described with reference to FIG. 5). The first and second connecting strap 92 are adapted to extend in front of the patient. Further, the first and second connecting strap 92 are adapted to be connected to the patient hoist 10. The first and second connecting strap 92 each comprises the rigid element 93.

In one embodiment, the rigid element is C-shaped and/or comprises the recess with the curved edge for interfacing with the patient hoist 10.

According to an aspect, a body support sling for supporting a patient is provided. The sling 100 comprises the leg support portion 60. The leg support portion 60 is adapted to support the thighs of a patient. The sling 100 comprises the torso support portion 70. The torso support portion 70 is adapted to support the torso of the patient. Further, the sling 100 comprises the connecting portion 40. The connecting portion 40 is adapted to be connected to the patient hoist 10.

The leg support portion 60 comprises the first leg support member 62 and the second leg support member 61. The leg support members each has the upper edge adapted to inclined from a first higher position proximal to the outer side of the thigh of the patient to the second lower position proximal to the inner side of the thigh of the patient.

This allows for an improved pressure distribution over the entire thigh which greatly improves the comfort. Further, the angled position of the leg support members reduces the risk for pinching etc.

According to an aspect, a body support sling for supporting a patient. The sling 100 comprises the leg support portion 60. The leg support portion 60 is adapted to support the thighs of a patient. The sling 100 comprises the torso support portion 70. The torso support portion 70 is adapted to support the torso of a patient. The sling 100 further comprises the connecting portion 40. The connecting portion 40 is adapted to be connected to the patient hoist 10.

As previously stated, the rigid element allows for some relative movement between the patient hoist and the patient strap during an aided raise that allows the patient to perform the rising motion. Further, the rigid element is more resistant to wear and tear compared to a textile or canvas strap for example.

The leg support portion 60 comprises the first leg support member 62 and the second leg support member 61. The first leg support member 62 is adapted to wrap around the first thigh of the patient. The second leg support member 61 is adapted to wrap around the second thigh of the patient.

Each of the first leg support member 62 and the second leg support member 61 comprises the torso attachment portion 67, 68 attached to the torso support portion 70. The torso attachment portion 67, 68 of the first leg support member 62 and the second leg support member 61 are each adapted to extend at an angle towards the back of the thighs of the patient when the sling 100 is worn by the patient.

This allows for sufficient support of the legs while allowing access for the care personnel to perform hygiene tasks to the patient since there may be sufficient space between the torso support portion and the leg support members.

According to an aspect a body support sling 100 for supporting a patient is provided. The sling comprises the leg support portion 60. The leg support portion 60 is adapted to support the thighs of the patient. The sling 100 further comprises the torso support portion 70. The torso support portion 70 is adapted to support the torso of a patient. The sling further comprises the connecting portion 40. The connecting portion 40 is adapted to be connected to the patient hoist 10.

The torso support portion 70 is adapted to wrap around the torso of the patient. The torso support portion 70 comprises the at least one coupling connection 73, 74. The at least one coupling connection 73, 74 is configured to releasably connect opposite ends of the torso support portion. Advantageously, said at least one coupling connection 73, 74 is arranged to be in front of the patient when the sling 100 is worn by the patient.

The leg support portion 60 comprises the first leg support member 62 adapted to wrap around the first thigh of the patient and the second leg support member 61 adapted to wrap around the second thigh of the patient. The first and second leg support member 62, 61 each comprises the first and second end. The first and second end are connectable by means of the leg support member connector 64, 63. Advantageously, the leg support member connectors 64, 63 are configured to be proximal to the front of the thigh of the patient when the sling 100 is worn by the patient.

This allows for the care personnel to make all adjustments in front of the patient which increases the sense of security for the patient and also simplifies the installation of the sling.

The invention has been described above in detail with reference to embodiments thereof. However, as is readily understood by those skilled in the art, other embodiments are equally possible within the scope of the present invention, as defined by the appended claims.

1. A body support sling for supporting a patient while said body support sling is worn by the patient, the body support sling comprising:
a leg support portion adapted to support the thighs of a patient;
a torso support portion adapted to wrap around the torso of the patient to support the torso of a patient; and
a connecting portion,
wherein the connecting portion comprises a front pair of suspension straps and a rear pair of suspension straps,
wherein the rear pair of suspension straps are attached to the torso support portion and are adapted to extend behind the patient and the front pair of suspension straps are attached to the torso support portion and are adapted to extend in front of the patient,
wherein the leg support portion comprises a first leg support member and a second leg support member each adapted to wrap around the thigh of the patient, respectively, and
wherein the first leg support member and the second leg support member each comprises a torso attachment portion attached to the torso support portion.

2-42. (canceled)

43. The body support sling according to claim 1, wherein the torso support portion comprises a guiding arrangement, whereby the front pair of suspension straps are adapted to pass through said guiding arrangement for securing a position of the front pair of suspension straps in front of the patient.

44. The body support sling according to claim 1, wherein the first leg support member and the second leg support member each has an upper edge adapted to be inclined from a first higher position proximal to an outer side of the thigh of the patient to a second lower position proximal to an inner side of the thigh of the patient.

45. The body support sling to claim 1, wherein the torso attachment portion of the first leg support member and the second leg support member each are adapted to extend at an angle towards the back of the thighs of the patient when the sling is worn by the patient.

46. The body support sling according to claim 1, wherein the first and second leg support member each comprise a thigh-wrapping portion adapted to wrap around the thigh of the patient, whereby the torso attachment portion of the first leg support member extends from the thigh-wrapping portion of the first leg support member to the torso support portion and the torso attachment portion of the second leg support member extends from the thigh-wrapping portion of the second support member to the torso support portion, and
wherein the thigh-wrapping portions are padded and the torso attachment portions are unpadded.

47. The body support sling according to claim 1, comprising a first connecting strap connected to the first leg support member and the torso support portion and a second connecting strap connected to the second leg support member and the torso support portion, whereby the first and second connecting strap are adapted to extend in front of the patient and be connected to an external patient hoist.

48. The sling according to claim 47, wherein the first and second connecting strap each comprises a rigid element, said rigid element being configured to be connected to the external patient hoist.

49. The sling according to the claim 1, wherein a first front suspension strap of the front pair of suspension straps is attached to an attachment point of the first leg support member and a second front suspension strap of the front pair of suspension straps is attached to an attachment point of the second leg support member.

50. The body support sling according to claim 1, wherein the torso support portion has a back portion adapted to provide back support to the patient when the body support sling is worn by the patient.

51. The body support sling according to claim 50, wherein the rear pair of suspension straps are attached to a common attachment point on the back portion of the torso support portion.

52. The body support sling according to claim 51, wherein the rear pair of suspension straps are arranged in a V-configuration from the common attachment point.

53. The body support sling according to claim 50, wherein the back portion of the torso support portion has a concave shape.

54. The body support sling according to claim 1, further comprising a chest strap connecting the front pair of suspension straps.

55. The body support sling according to claim 54, wherein the chest strap is adjustable to alter the distance between the front pair of suspension straps.

56. The sling according to claim 55, wherein the chest strap is adjustable along the length of the front pair of suspension straps

57. The sling according to claim 54, wherein the chest strap is adjustable along the length of the front pair of suspension straps.
